(19) United States
(12) Patent Application Publication
(10) Pub. No.: US 2005/0136386 A1
(43) Pub. Date: Jun. 23, 2005

(54) Distance learning system

(76) Inventors: Thomas Nello Giaccherini, Carmel Valley, CA (US); David Lacis Payne, Morgan Hill, CA (US); James Riley Stuart, Louisville, CO (US); Mark Alan Sturza, Encino, CA (US)

Correspondence Address: Thomas N. Giaccherini, Post Office Box 1146, Carmel Valley, CA, 93924, US

(21) Appl. No.: 10/742,568

(22) Filed: Dec. 19, 2003

(51) Int. Cl. G09B 7/00

(52) U.S. Cl. 434/323

(57) ABSTRACT

Methods and apparatus for gradually and automatically distributing educational content to students is disclosed. In one embodiment, content is transmitted using subcarriers or sidebands of conventional FM broadcasts to gradually convey audio programs to wireless portable receivers which automatically store the received content until the listener is ready to learn.

### CROSS-REFERENCE TO RELATED PENDING PATENT APPLICATIONS & CLAIMS FOR PRIORITY

The present Patent Application is a Continuation-in-Part Application, which is related to:
U.S. patent application Ser. No. 09/579,324, SkyVault™ Parent, filed on 25 May 2000;
U.S. patent application Ser. No. 09/688,997, CIPA-SkyVault™, filed on 16 Oct. 2000;
U.S. patent application Ser. No. 09/833,094, CIPB-RainBarrel™, filed on 10 Apr. 2001;
U.S. patent application Ser. No. 09/948,021, CIPC-GameVault™, filed on 6 Sep. 2001;
U.S. patent application Ser. No. 10/094,943, CIPE-SoftwareVault™, filed on 11 Mar. 2002;
U.S. patent application Ser. No. 10/112,810, CIPF-InfoVault™, filed on 1 Apr. 2002;
U.S. patent application Ser. No. 10/112,826, CIPG-OmniMarketing™ System, filed on 1 Apr. 2002;
U.S. patent application Ser. No. 10/316,976, CIPJ-Wireless Automatic Content Reservoir™, filed on 11 Dec. 2002;
U.S. patent application No. 10/405,888, CIPK-RadioVault™, filed on 2 Apr. 2003;
U.S. patent application Ser. No. 10/411,880, CIPL-Wireless Content Distribution System, filed on 10 Apr. 2003;
U.S. patent application Ser. No. 10/459,726, CIPM-CarVault™, filed on 2 Jun. 2003;
U.S. patent application Ser. No. 10/452,770, CIPN-Wireless Automatic Data Distribution, filed on 11 Jun. 2003;
U.S. patent application Ser. No. 10/459,727, CIPO-ConstructionVault™, filed on 11 Jun. 2003;
U.S. patent application Ser. No. 10/638,947, CIPP-GlobalProjectVault™, filed on 11 Aug. 2003;
U.S. patent application Ser. No. 09/887,570, UltraSecure™ Digital Rights Management & Key Protection System, filed on 22 Jun. 2001;
U.S. patent application Ser. No. XX/XXX,XXX, UltraSecure™ Digital Rights Management & Key Protection System CIPA, filed on 14 Nov. 2003;
U.S. Design patent application Ser. No. 29/172,410, Wireless Automatic Content Reservoir™, filed on 11 Dec. 2002;
PCT International Patent Application No. PCT/US01/14828, SkyVault™, filed on 23 May 2001;
PCT International patent application No. PCT/GB02/05612, UltraSecure™, filed on 11 Dec. 2002;
European Patent Application No. 01939003.8-2211-SkyVault™;
Japanese Patent Application No. 2002-500564-SkyVault™; and
Canadian Patent Application No. 2410291-SkyVault™.

The Applicants hereby claim the benefit of priority under Sections 119 & 120 of Title 35 of the United States Code of Laws for any and all subject matter shared by the present application and any of the co-pending applications listed above.

### INTRODUCTION

The title of this Continuation-in-Part patent appliation is Distance Learning System. The Applications are:
Thomas Nello Giaccherini Post Office Box 1146, Carmel Valley, Calif. 93924-1146
David Lacis Payne 3430 White Oak Court, Morgan Hill, Calif. 95037
Dr. James Riley Stuart 1082 West Alder Street, Louisville, Colo. 80027-1046; and
Mark Alan Sturza 16161 Ventura Boulevard, Suite 815, Encino, Calif. 91436.

All the Inventors are all Citizens of the United States of America.

### FEDERALLY SPONSORED RESEARCH OR DEVELOPMENT

None.

### FIELD OF THE INVENTION

The present invention pertains to methods and apparatus for distributing educational and other content using excess capacity in existing networks. More particularly, one preferred embodiment of the invention employs conventional radio transmitters to gradually and automatically broadcast educational content to wireless receivers. The content is accumulated and stored the receiver, and is selected, and then played or used at the students' convenience.

### BACKGROUND OF THE INVENTION

Millions of Americans would be grateful to have the opportunity to supplement, enhance or continue their educations, but many are at work, busy at home or otherwise unable to find a convenient time to pursue additional learning.

No current commercially-available device or system enables persons to listen to and/or view educational content which is automatically delivered to students electronically without the students' intervention, at a time chosen by the student, and which does not require a personal computer and an Internet connection. The development of such a system would constitute a major technological advance, and would satisfy long felt needs and aspirations in the fields of broadcasting, information and education.

### SUMMARY OF THE INVENTION

The present invention employs networks to gradually and automatically distribute educational and other content to persons equipped with wireless terminals. In one embodiment, educational content is transmitted using subcarriers or sidebands of conventional FM broadcasts to gradually convey audio programs to receivers which automatically store the received content until the listener is ready to learn. Another embodiment of the invention includes both audio and video content.

In one embodiment of the invention, educational content is acquired from content providers such as schools, colleges, universities or private companies. This content is conveyed to a central Operations Center. The recorded content may need to be converted to a digital stream. This digital file is then dispatched to the Operations Center of a national chain of FM radio stations. The digital file may need to be compressed, and is then broadcast at relatively slow data rates to wireless receivers. In one embodiment, the small portable receiver comprises an FM antenna and receiver which is coupled to a storage device such as a flash memory. The content is played back through lightweight headphones. The educational content is gradually conveyed or “RainBarreled™” to customers via an inexpensive point-to-multi-point distribution method. When the student wishes to listen and learn, the content is ready for playback without computer downloads, streaming or Internet connections. In one embodiment of the invention, the receiver is adapted to receive and store a number of content programs, enabling the student to select from a menu of learning opportunities. The content programs may be periodically and automatically replaced with new programs.

An appreciation of the other aims and objectives of the present invention, and a more complete and comprehensive understanding of this invention, may be obtained by studying the following description of a preferred embodiment, and by referring to the accompanying drawings.

### A BRIEF DESCRIPTION OF THE DRAWINGS

FIG. 1 is a schematic diagram which illustrates a set of content providers that convey content to a Network Operations Center which then broadcasts content gradually and automatically to receivers using the excess capacity in existing networks.

FIG. 2 depicts one embodiment of the invention. Audio and video files containing educational content is delivered to the Operations Center. The recording may need to be converted to a digital file. The file is then gradually broadcast to wireless portable receivers using FM subcarriers. After the program of content is delivered to the wireless receivers, students may select content and listen at a time which they choose. In another embodiment of the invention, audio and video files may be delivered to a terminal like a television or a personal computer.

FIGS. 3 and 4 supply schematic renditions of an audio receiver, which comprises an FM antenna and receiver, a storage device such as a flash memory or hard drive, playback control circuitry, content selector, and headphones and/or a speaker.

FIG. 5 provides a schematic depiction of groups of students listening to or watching distance learning content on audio equipment, or using a television or a personal computer. The a library of content, “The World's Greatest Teachers™,” is maintained at “The LearningVault,™” and is conveyed wirelessly via radio or satellite signals to students around the globe. Both Trade & Service Marks “The World's Greatest Teachers,™” is maintained at “The LeamingVault™” are Trade & Service Marks which are owned by the Assignee of this U.S. patent application.

### A DETAILED DESCRIPTION OF PREFERRED & ALTERNATIVE EMBODIMENTS

I. Overview of the Invention

The present invention comprises methods and apparatus for delivering educational content and/or other information to students using the unused, excess capacity that is inherent in virtually all communication networks using the RainBarrel™ Method. The Trade & Service Mark “RainBarrel™” is owned by the Assignee of this U.S. patent application.

In this Specification and in the Claims that follow, the terms “content” “information” “program” and “educational content” encompass any form of code, data, books, written or printed materials, audio, video, visual works, motion pictures, photographs, music, text, games, software, graphics or other manifestation of intelligence, knowledge, pattern or expression. Content may include lessons, briefings, lectures, meetings, tutorials, discussions, presentations, seminars, debates, deliberations of government or private bodies, or training sessions. In general, content is presented to a student or students in the form of a “program,” which connotes the playback, representation, audition, rendering, reproduction or other manifestation of content conveyed using the present invention.

The term “excess capacity” includes any unused or underutilized transmission capability of an electromagnetic or other emanation, including radio subcarriers and sidebands. Excess capacity includes any conveyance of any content using any network, irrespective of the portion of the network capacity which is actually consumed at any given moment or during any specific time interval. If, for example, a RainBarrel™ signal consumes 100% of the transmission capacity of an FM signal or satellite transponder for a given interval of time because the primary signal is absent, the RainBarrel™ signal is, nonetheless, a signal which utilizes excess capacity for its conveyance. The RainBarrel™ Method allows for the automatic transmission of content without user intervention, and then enables the user to select content and use or play the content at a time chosen by the user. The delivery of content to the user is generally accomplished without any user action, and is generally controlled by the transmitter. The consumption or use of the content is generally controlled, determined and selected by the user, without any action by the transmitter, with the possible exception of the verification of an account over a return channel.

In this Specification and in the Claims that follow, the term “network” connotes any group of one or more transmitters, transponders, emitters, repeaters, nodes, sources, emanations, signals, computers, servers, storage devices, archives, broadcast facilities, terminals, receivers or other hardware, software or means for conveying content.

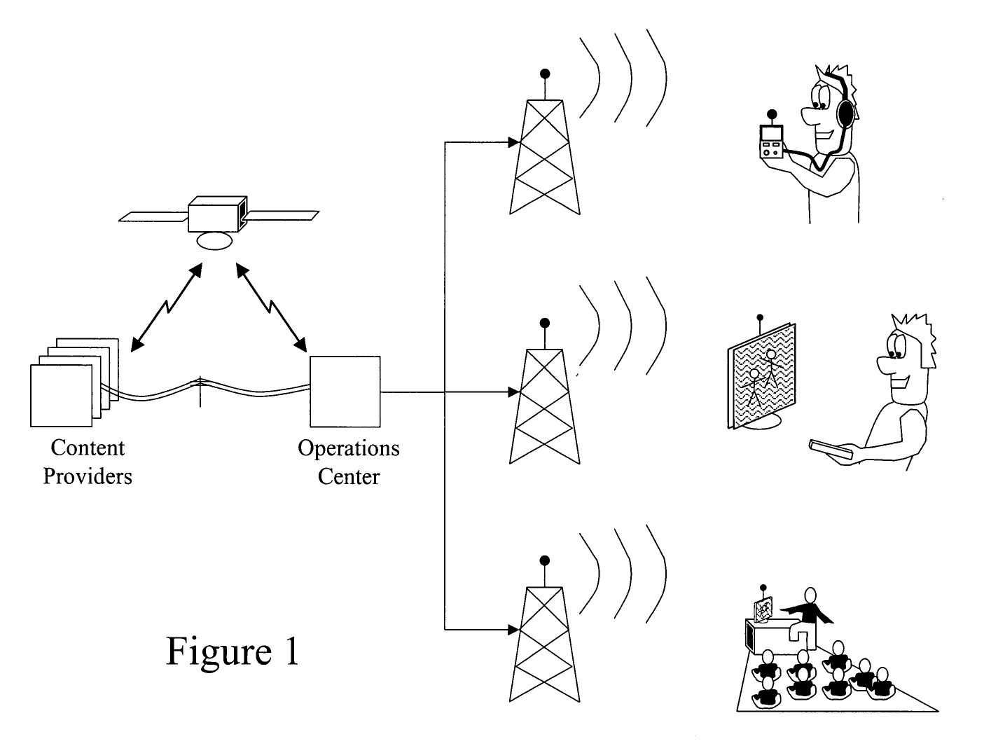

FIG. 1 is a schematic illustration of one embodiment of the invention. Content Providers may be connected to an Operations Center by wired, wireless or other communications links, including satellite links. Content may also be shipped to the Operations Center in the form of physical recordings on records, on tape, on disc or in some other form. In this Specification and in the Claims that follow, the terms “Content Provider” refers to any source, origin, repository, archive, network node, repeater, transmitter or rebroadcaster of content or information as defined above. The person who receives the content may be a student, a subscriber, a customer, an employee or some other user or recipient of the content.

In this Specification and in the Claims that follow, the term “Operations Center” encompasses any hardware, software, facility or switching, routing or transmitting node which may be used to implement the Invention. In one embodiment of the invention, content is provided by educational organizations, such as schools, adult education centers, language labs, colleges, universities, government agencies, military entities, training centers, private companies, churches or religious groups, individuals, or other groups which produce other educational or other content.

The Operations Center is connected by wired, wireless or other communications links to one or more FM radio transmitters. While the preferred embodiment utilizes a network of FM broadcasters, alternative embodiments of the invention may utilize many different telecommunications links and nodes, including, but not limited to, satellites, television, cellular telephone, land lines, computer networks including the Internet, and radio systems operating in frequencies other than the FM band. While conventional radio stations may offer service areas or “footprints” covering large geographic regions, a single satellite may provide distance learning to an entire continent.

The content is conveyed from the Operations Center to the conventional transmitters. The content is gradually conveyed by these transmitters to mobile or fixed receivers at the students' and/or customers' premises, as shown in FIG. 1. Unlike conventional broadcasts, the content is inserted, injected or otherwise combined at relatively low data rates with conventional broadcast content using sidebands, subcarriers or other unutilized transmission capacity within a conventional broadcast signal. The invention is not restricted to the use of low speed transmission, but, rather, can utilize any and all available excess capacity, up to and including the total capacity of a network for a given interval of time. This “RainBarrel™ Method” is described in greater detail in Section II of this Specification.

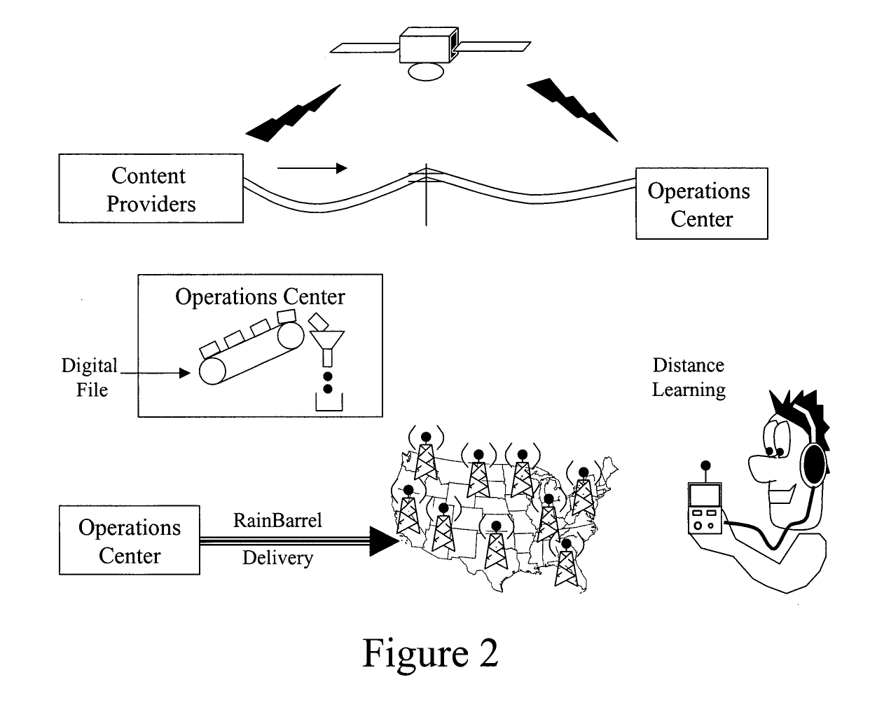

FIG. 2 portrays a specific embodiment of the invention. Content from an educational organization is obtained by the Operations Center. As examples, this content may teach English as a Second Language, High School Equivalency, Vocational Education or Basic Math Skills. Virtually any content may be conveyed by the present invention to provide distance learning. The invention may also be employed to convey scriptural or religious instruction. In some instances, the content may need to be converted into digital files, and then may need to be compressed to reduce the size of the files. This compression may be important because it enables more efficient distribution of the content to the student. The compressed or uncompressed digital files are transmitted to student receivers in the service area or footprint of transmitters using the RainBarrel™ Method. In one early embodiment of the invention, content is planned for transmission to students in California, Arizona, Nevada and New Mexico using radio transmitters in Los Angeles, Phoenix, Las Vegas and Albuquerque.

After transmission, the content is automatically stored in the receivers, enabling the student to listen to the audio content at a time chosen by him or her. Unlike conventional broadcasts, the recipient of the content enjoys the freedom to listen to the content he or she selects for “on-demand” reproduction at the time of his or her choosing. The receiver may be programmed to automatically overwrite stored programs with new programs in a given period, or may be programmed to save particular programs without refreshing the memory with new content.

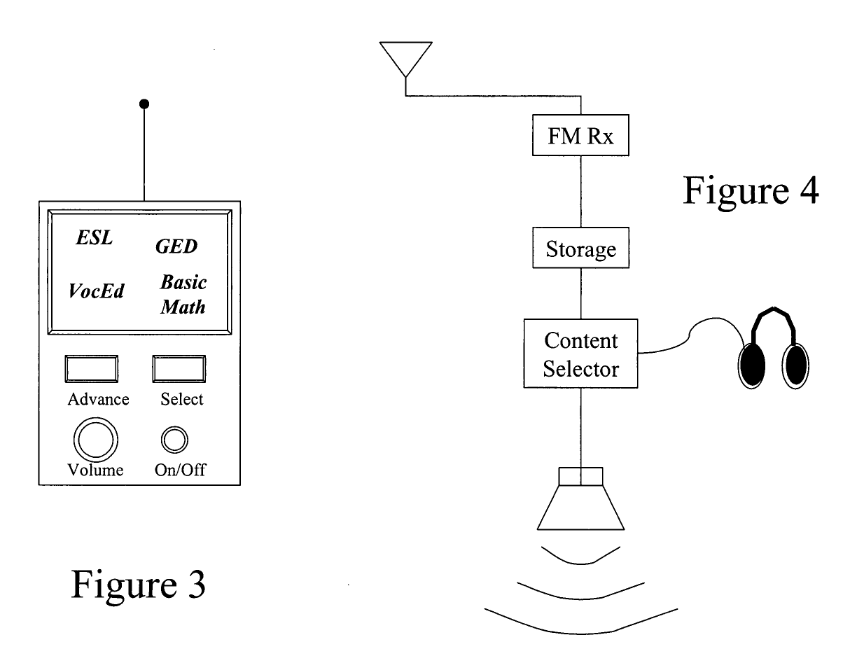

FIGS. 3 and 4 are schematic illustrations of a wireless receiver that may be used to implement the invention. While this embodiment is manifested as a hand-held, portable device, the receiver may be incorporated into a car radio, a cell phone, a television, a computer, a fixed terminal or any other suitable device or appliance. In a preferred embodiment, the receiver weighs less than a pound, and resembles a Sony® Walkman® device. The user may select content by viewing an LCD screen or some other equivalent display, switch or control. Suitable push button or other controls are employed to navigate through the content listing or menu. The receiver also includes an on/off switch and a rotary or slide bar volume control. FIG. 4 is a simplified circuit diagram of the receiver shown in FIG. 3. An FM antenna is attached to an FM receiver. The appropriate FM signal is demodulated, and a digital file of received audio content is stored in a storage device or memory like a hard drive or a solid state chip or “flash memory.” A playback control circuit allows the user to regulate the play of the audio program over a speaker or through headphones. While FM radio is the spectrum of choice for transmission in one embodiment, other spectra, including AM radio, cell phone frequencies, television or satellite channels may be employed. In another embodiment of the invention, audio and video content are conveyed to receivers like televisions and/or personal computers. In some parts of the world where only one receiver is available to a village or other group of persons, a satellite may be employed to convey content to a single “community receiver” such as a television. A specially adapted satellite receiver may be used in conjunction with a conventional television for this implementation of the invention.

The audio receiver may adapted to receive both conventional radio broadcasts, and the additional educational content. In one embodiment of the invention, the receiver includes a second FM receiver chip for the additional program, or includes a single customized chip that is able to demodulate both the conventional signal and the additional program, and convert both signals to audible sound. One embodiment of the receiver includes software and/or hardware that enables the receiver to detect which stations broadcasting in the customers' area is providing the additional audio program, and then automatically tunes to that station or stations to receive the program from the Content Provider. Unlike a conventional radio, which is only able to receive and play conventional broadcasts, the receiver used to implement the present invention is able to receive both conventional broadcasts and the additional program.

In an alternative embodiments of the invention, the receiver may be incorporated into or adapted to work in a motor vehicle, a cell phone, a computer or any appliance, apparatus or electronic device.

In one embodiment of the invention, the content delivered to the consumers' receivers is educational content which is delivered free of charge to students. In another embodiment, users may be charged for programs supplied by the invention. Revenue may be generated by either charging customers a subscription for providing content, or by providing free content combined with charges to advertisers for commercial messages included in the programs.

II. The UltraSecure™ Digital Rights Management & Key Protection System

In one embodiment of the invention, the receiver may include a security chip which may be used to regulate the use of content and/or to thwart unauthorized copying or playing of content. The reader is invited to refer to U.S. patent application Ser. No. 09/887,570, filed on 22 Jun. 2001; and to PCT International patent application No. PCT/US01/14828 filed on 23 May 2001, both entitled Method for Secure Delivery of Digital Content. These commonly-owned and commonly-assigned patent applications describe the UltraSecure™ Digital Rights Management & Key Protection System, and the contents of these two applications are hereby incorporated by reference into this application. The Trade & Service Mark “UltraSecure™” is owned by the Assignee of this U.S. patent application.

III. The RainBarrel™ Method

Preferred & Alternative Implementations of the Invention

In one embodiment of the invention, the digital files containing educational or other content are conveyed over wired or wireless connections from the Operations Center to the network headquarters of an FM radio network. The native or compressed digital files are added, combined or otherwise commingled with the conventional broadcast signal, and are gradually transmitted to receivers. In one embodiment of the invention, an FM subcarrier is leased from a national network of radio stations. A server is installed at the headquarters of the national network, and content is conveyed from Content Providers and/or an Operations Center. In one embodiment the headquarters of the national network may serve as the Operations Center. The server is configured to inject, combine or otherwise add the audio program from the Content Providers with the conventional FM signal using a subcarrier or sideband. The addition of the educational content from the Content Providers to the conventional radio broadcast does not affect the reception of the conventional program by listeners with conventional radios, since the conventional radios are not configured to receive the additional audio program. Only customers with specially adapted receivers are able to receive the educational content from the Content Providers. The specially adapted receivers may also be used to simply monitor conventional broadcasts.

FM Broadcast Station Channels

The frequency modulation (FM) broadcast band in the US ranges from 88 to 108 MHz. The band is divided into 100 channels of 200 kHz bandwidth each. The channel center frequencies are given by:
f₀=88.1+n×0.2 MHz where n=0 to 99 Equation (1)

In the U.S., 47 CFR 73.293 authorizes FM broadcast stations to “transmit subcarrier communications services.” One implementation of data delivery using FM radio broadcasting stations is a subcarrier at the channel center frequency modulated by a shaped-offset, Quadraphase Shift Keying (QPSK) waveform, with shape factor of 1.25, at 80 kbps. This provides a 160 kbps transmission rate of raw data. The delivered data is partitioned into 512 byte (4,096 bit) packets. The first twelve bytes of each packet are used for synchronization, address and flag fields. The remaining 500 bytes contain payload data with rate ⅘ turbo code, FEC. The resulting data transmission rate is 125 kbps, or 1.36 gigabytes (GBytes) per day for one FM broadcasting station.

AM Broadcasting Station Channels

The amplitude modulation (AM) radio broadcast band in the US ranges from 535 to 1705 kHz. It is divided into 117 channels of 10 kHz bandwidth each. Center frequencies in kHz are given by:
f₀=540+n×10 kHz for n=0 to 116 Equation (2)

AM broadcasting stations transmit at 50 kilowatts. In the US, 47 CFR 73.127 authorizes AM broadcast stations “to transmit signals not audible on ordinary consumer receivers, for both broadcast and non-broadcast purposes.”

One implementation of data delivery using AM broadcasting stations is a subcarrier at the channel center frequency modulated by a 256-Quadrature Amplitude Modulation (QAM) waveform, with shape factor 1.25, at 8 kilobits per second (kbps). This provides a 64 kbps transmission rate of raw data. The symbols are trellis-coded at rate ⅞ to provide FEC, resulting in a data rate of 56 kbps. The data is partitioned into 512 byte (4,096 bit) packets. The first 16 bytes of each packet are used for synchronization, address and flag fields. The remaining 496 bytes contain data. The resulting data transmission rate is 64.25 kbps, or 585.9 MBytes per day for each AM radio station.

Cellular CDPD

The Cellular Digital Packet Data (CDPD) network provides digital data over existing North American cellular networks by taking advantage of the idle time on analog AMPS channels to transmit packet data at 19.2 kbps. There are 666 AMPS channels between 870 and 890 MHz in the forward direction, and between 825 and 345 MHz in the reverse direction. The channels have 30 kHz bandwidths. There are 42 radio frequency (RF) control channels which cannot be used for CDPD. The data is Gaussian Minimum Shift Keying (GMSK) modulated with a bandwidth time product (BT) of 0.5. CDPD supports two-way communication, so only minimal FEC is required. Allowing 1.2 kbps for packet overhead and FEC, there remains eighteen kbps for data transmission, or 194 MBytes of data per day, per cellular channel used.

Local, Non-Standard Data Delivery Methods

FM Subcarriers

47 CFR 73.293 authorizes FM broadcast stations to “transmit subcarrier communications services in the United States.” Broadcast FM stations have been using subcarriers since the 1950's for things like Muzak music delivered to individual and company subscribers. Data broadcasting is more recent, but already in use for things like differential Global Positioning System (GPS) corrections, traffic data, stock quotes, etc.

One implementation of data delivery by FM subcarrier is the Radio Broadcast Data System (RBDS). A 57 kHz subcarrier is used, which is amplitude modulated by shaped biphase, differentially-coded, encoded digital data at 1.1875 kbps. The baseband data is packetized into groups of 104 bits. Each group is divided into 4 blocks of 26 bits each, and each block is further divided into 18 data bits and 10 check bits. This results in a 0.615 code rate, and a 730.8 bps information rate. Data transmission of this type is 7.9 MBytes per day.

Another implementation is Data Radio Channel (DARC). A 76 kHz Level Minimum Shift Keying (LMSK) subcarrier, modulated at 16 kbps raw bit rate, is injected into the composite FM signal at 10% modulation (−20 dB). The 16 kbps raw bit rate is equivalent to 173 MBytes per day. Adding frame and address overhead at 20%, and rate_forward error correction, a data rate of 10 kbps, or 108 MBytes per day can be achieved. A more efficient modulation scheme can provide a 56 kbps raw bit rate, equivalent to a 35 kbps data transmission rate, or 378 MBytes of data delivery per day per FM station.

AM Subcarriers

In the U.S., 47 CFR 73.127 authorizes AM broadcast stations to transmit subcarriers.

Satellite Delivery

The present invention may also be implemented using satellite signals, using any suitable frequency band. Currently available satellite services such as DirecTV™, EchoStar™, Sirius Satellite Radio™ or XM Satellite Radio™ may be utilized to convey content using the RainBarrel™Method.

IV. Compression & Data Rates

In general, current known compression methods allow digital files to be compressed so that one minute of program is reduced to a one megabyte file. To achieve higher reproduction quality, more complicated compression methods may be employed. To obtain “FM quality” sound, the invention may utilize the following compression methods, which are generally well known in the art:
CD Transparent Audio (160 Kbps-16 bit, 44.1 KHz, Stereo audio) One minute of audio compresses to a file size of approximately 1.14 MB. About 9:1 compression.
CD Quality Audio (128 Kbps-16 bit, 44.1 KHz, Stereo audio) One minute of audio compresses to a file size of approximately 0.91 MB. About 11:1 compression.
Near CD Quality Audio (96 Kbps-16 bit, 44.1 KHz, Stereo audio) One minute of audio compresses to a file size of approximately 0.68 MB. About 14:1 compression.
FM Radio Quality Audio (64 Kbps-16 bit, 22 KHz, Stereo audio) One minute of audio compresses to a file size of approximately 0.45 MB. About 22:1 compression.

If FM Quality compression is selected, then one hour of audio is 0.45 MB×60 minutes=27 MB of audio program that must be conveyed to receivers using the RainBarrel™ Method. A single subcarrier is able to convey approximately 100 MB per day, or about 4.2 MB per hour. If the Vertical Blanking Interval of a television broadcast were employed, the RainBarrel™ data rate would be 2.5 GB a day, which is over 100 MB an hour.

V. The LearningVault™ Library of Greatest Teachers™

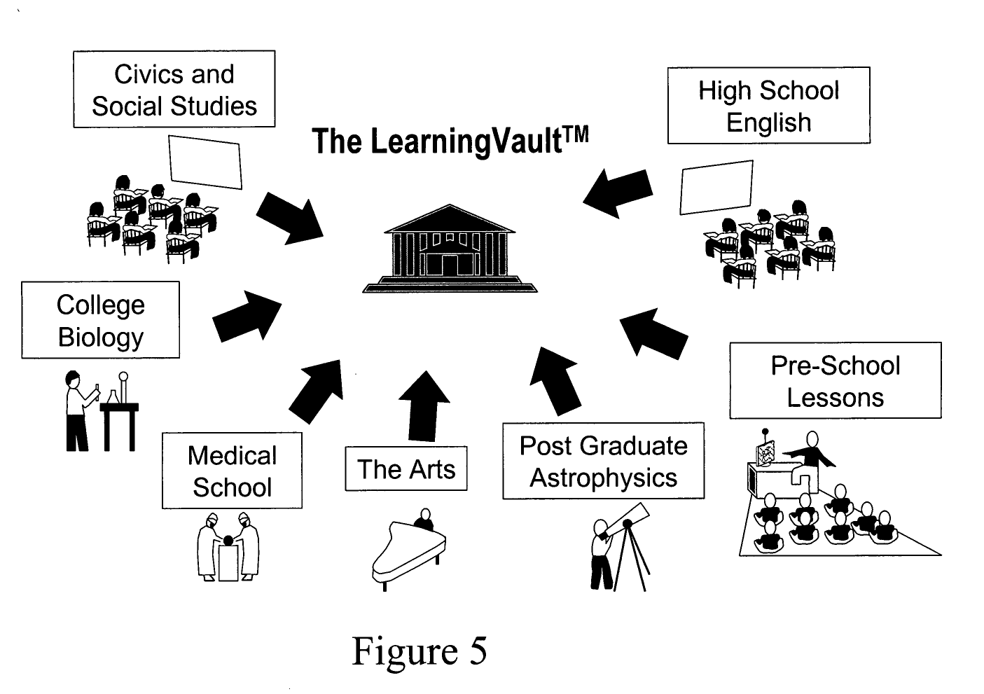

In one embodiment of the invention, audio and video recordings of accomplished and eminent teachers are assembled into a Library of Greatest Teachers™. As shown in FIG. 5, the best teachers in their respective fields are sought out, and their presentations, lessons, and lectures are recorded without charge to the teacher or educational institution. In some instances, the teacher may receive a royalty for the reproduction of the recorded presentation. All types of educational content are recorded, starting with pre-school and elementary school, through middle and high school, up through and including college, post-graduate and professional schools such as law, medicine and business. These presentations are also translated into many different languages. This library is then conveyed to students around the world free of charge. This service is enabled by government and private grants, charitable donations and funding from institutions such as the United Nations and the World Bank.

In one embodiment of the invention, content is delivered to public or private schools as an educational supplement. In another embodiment of the invention, content conveyed by the invention may be utilized for adult education or home schooling.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Distance Learning System that have been disclosed above are intended to educate the reader about preferred embodiments of the invention, and are not intended to constrain the limits of the invention or the scope of Claims.

1. A method comprising the steps of:
obtaining content;
broadcasting said content to a receiver electronically using excess capacity in a network; and
storing said content in said receiver for on-demand use at a future time.

2. A method as recited in claim 1, in which said content is educational content.

3. A method as recited in claim 1, in which said content is an audio program.

4. A method as recited in claim 1, in which said content is an audio recording which is subsequently converted to a digital file.

5. A method as recited in claim 4, in which said digital file is compressed before it is conveyed to said receiver.

6. A method as recited in claim 4, in which said digital file is broadcast to said receiver using an FM transmitter.

7. A method as recited in claim 6, in which said digital file is broadcast using an FM subcarrier.

8. A method as recited in claim 7, in which said digital file is broadcast using an FM sideband.

9. A method as recited in claim 1, in which said receiver comprises an FM antenna, an FM subcarrier receiver, and a storage device.

10. A method as recited in claim 9, in which said storage device is a solid state memory.

11. A method as recited in claim 1, in which said content is automatically overwritten with new content unless the user intervenes.

12. A method as recited in claim 1, in which said receiver is a portable device.

13. A method as recited in claim 1, in which said receiver is incorporated into a motor vehicle.

14. A method as recited in claim 1, in which said receiver is incorporated into a cell phone.

15. A method as recited in claim 1, in which said receiver is incorporated into a computer.

16. A method as recited in claim 1, in which revenue is generated by charging a subscription for providing said content.

17. A method as recited in claim 1, in which revenue is generated by charging an advertiser for providing a commercial message during said content.

18. A method as claimed in claim 1, further including the step of transmitting said content by an AM radio broadcast station on an existing channel.

19. A method as claimed in claim 18, in which the step of transmitting said content by an AM radio broadcast station on an existing channel includes the step of transmitting said content by signals not audible on ordinary consumer receivers.

20. A method as claimed in claim 18, in which the step of transmitting said content by an AM radio broadcast station on an existing channel includes the step of modulating a subcarrier at a center frequency of said channel.

25. A method as claimed in claim 1, further including the step of transmitting said content by an FM radio broadcasting station on an existing channel.

26. A method as claimed in claim 25, in which the step of transmitting said content by an FM radio broadcast station on an existing channel includes the step of modulating a subcarrier at a center frequency of said channel.

27. A method as recited in claim 1, in which an FM subcarrier operated by a radio network is employed to broadcast said content to said receiver.

28. A method as recited in claim 1, in which an FM sideband operated by a radio network is employed to broadcast said content to said receiver.

29. An apparatus comprising:
an FM antenna;
an FM receiver; said FM antenna being connected to said FM receiver; and
a storage device; said storage device being connected to said FM receiver;
said FM receiver for receiving a gradual, automatic and wireless transmission of information which is loaded on said storage device for use by a customer on-demand.

30. A method comprising the steps of:
conveying a program of content to a user;
equipping said user with a wireless receiver;
receiving said program of content without the intervention of said user;
storing said program of content automatically without the intervention of said user; and
enabling said user to select content for reproduction at a time chosen by said user.

31. A method as recited in claim 30, in which said program of content is an audio program.

32. A method as recited in claim 30, in which said program of content includes both audio and video content.

33. A method as recited in claim 30, including the additional step of:
compiling a library of educational presentations by a plurality of eminent educators.

34. A propagated signal comprising:
a plurality of programs of educational content;
said plurality of programs of educational content being wirelessly and automatically conveyed to a user equipped with a wireless terminals having an on-board storage device using excess capacity in a network;
said user selecting from programs of educational content that have been automatically stored in said wireless terminal;
said user controlling the time of use of said content.

35. A method as recited in claim 1, in which said content is delivered to a public school.

36. A method as recited in claim 1, in which said content is delivered to a private school.

37. A method as recited in claim 1, in which said content is used for adult education.

38. A method as recited in claim 1, in which said content is used for home schooling.

39. A method comprising the steps of:
broadcasting content to a receiver wirelessly without the intervention of a user;
automatically storing said content in said receiver;
enabling a user to select a portion of said content stored in said receiver; and
reproducing said selected content stored in said receiver at a time chosen by said user.
